(19) United States
(12) Patent Application Publication
(10) Pub. No.: US 2008/0182153 A1
(43) Pub. Date: Jul. 31, 2008

(54) Fuel cell electro-catalyst composite composition, electrode, catalyst-coated membrane, and membrane-electrode assembly

(76) Inventors: Bor Z. Jang, Centerville, OH (US); Aruna Zhamu, Centerville, OH (US); Jiusheng Guo, Centerville, OH (US)

Correspondence Address: Bor Z. Jang, 9436 Parkside Drive, Centerville, OH, 45458, US

(21) Appl. No.: 11/699,176

(22) Filed: Jan. 30, 2007

(51) Int. Cl. H01M 4/00

(52) U.S. Cl. 429/41

(57) ABSTRACT

Disclosed are an electro-catalyst composition and a precursor electro-catalyst composition (e.g., ink or suspension) for use in a fuel cell that exhibits improved power output. The electro-catalyst composition comprises: (a) a catalyst un-supported or supported on an electronically conducting carrier (e.g., carbon black particles); and (b) an ion-conducting and electron-conducting coating material in physical contact with the catalyst and/or coated on a surface of the carrier, wherein the coating material has an electronic conductivity no less than 10⁻⁴ S/cm (preferably no less than 10⁻² S/cm) and an ion conductivity no less than 10⁻⁵ S/cm (preferably no less than 10⁻³ S/cm). Also disclosed are a fuel cell electrode comprising this composition, a membrane-electrode assembly (MEA) comprising this composition, and a fuel cell comprising this composition.

### FIELD OF THE INVENTION

This invention relates to an electro-catalyst composite composition that can be used in a fuel cell electrode, a catalyst-coated membrane (CCM), or a membrane-electrode assembly (MEA). The composite composition forms an electrode that is both ion- and electron-conductive, which is particularly useful for ion exchange membrane-type fuel cells, particularly proton-conducting membrane fuel cells (PEM-FC).

### BACKGROUND OF THE INVENTION

The proton exchange membrane or polymer electrolyte membrane fuel cell (PEM-FC) has been a topic of highly active R&D efforts during the past two decades. The operation of a fuel cell normally requires the presence of an electrolyte and two electrodes, each comprising a certain amount of catalysts, hereinafter referred to as electro-catalysts. A hydrogen-oxygen PEM-FC uses hydrogen or hydrogen-rich reformed gases as the fuel while a direct-methanol fuel cell (DMFC) uses methanol solution as the fuel. The PEM-FC and DMFC, or other direct organic fuel cells, are collectively referred to as the PEM-type fuel cell.

A PEM-type fuel cell is typically composed of a seven-layered structure, including a central polymer electrolyte membrane for proton transport, two electro-catalyst layers on the two opposite sides of the electrolyte membrane in which chemical reactions occur, two gas diffusion layers (GDLs) or electrode-backing layers stacked on the corresponding electro-catalyst layers, and two flow field plates stacked on the GDLs. Each GDL normally comprises a sheet of porous carbon paper or cloth through which reactants and reaction products diffuse in and out of the cell. The flow field plates, also commonly referred to as bipolar plates, are typically made of carbon, metal, or composite graphite fiber plates. The bipolar plates also serve as current collectors. Gas-guiding channels are defined on a surface of a GDL facing a flow field plate, or on a flow field plate surface facing a GDL. Reactants and reaction products (e.g., water) are guided to flow into or out of the cell through the flow field plates. The configuration mentioned above forms a basic fuel cell unit. Conventionally, a fuel cell stack comprises a number of basic fuel cell units that are electrically connected in series to provide a desired output voltage. If desired, cooling and humidifying means may be added to assist in the operation of a fuel cell stack.

Several of the above-described seven layers may be integrated into a compact assembly, e.g., the membrane-electrode assembly (MEA). The MEA typically includes a selectively permeable polymer electrolyte membrane bonded between two electrodes (an anode and a cathode). A commonly used PEM is poly (perfluoro sulfonic acid) (e.g., Nafion® from du Pont Co.), its derivative, copolymer, or mixture. Each electrode typically comprises a catalyst backing layer (e.g., carbon paper or cloth) and an electro-catalyst layer disposed between a PEM layer and the catalyst backing layer. Hence, in actuality, an MEA may be composed of five layers: two catalyst backing, two electro-catalyst layers, and one PEM layer interposed between the two electro-catalyst layers. Most typically, the two electro-catalyst layers are coated onto the two opposing surfaces of a PEM layer to form a catalyst-coated membrane (CCM). The CCM is then pressed between a carbon paper layer (the anode backing layer) and another carbon paper layer (the cathode backing layer) to form an MEA. It may be noted that, some workers in the field of fuel cells refer a CCM as an MEA. Commonly used electro-catalysts include noble metals (e.g., Pt), rare-earth metals (e.g., Ru), and their alloys. Known processes for fabricating high performance MEAs involve painting, spraying, screen-printing and hot-bonding catalyst layers onto the electrolyte membrane and/or the catalyst backing layers.

An electro-catalyst is needed to induce the desired electrochemical reactions at the electrodes or, more precisely, at the electrode-electrolyte interfaces. The electro-catalyst may be a metal black, an alloy, or a supported metal catalyst, for example, platinum supported on carbon. In real practice, an electro-catalyst can be incorporated at the electrode-electrolyte interfaces in a PEM fuel cell by depositing a thin film of the electro-catalyst on either an electrode substrate (e.g., a surface of a carbon paper-based backing layer) or a surface of the membrane electrolyte (the PEM layer). In the former case, electro-catalyst particles are typically mixed with a liquid to form a slurry (ink or paste), which is then applied to the electrode substrate. While the slurry preferably wets the substrate surface to some extent, it must not penetrate too deeply into the substrate, otherwise some of the catalyst will not be located at the desired membrane-electrode interface. In the latter case, electro-catalyst particles are coated onto the two primary surfaces of a membrane to form a catalyst-coated membrane (CCM). The slurry, ink, or paste is hereinafter referred to as a precursor electro-catalyst composition.

Electro-catalyst sites must be accessible to the reactants (e.g., hydrogen on the anode side and oxygen on the cathode side), electrically connected to the current collectors, and ionically connected to the electrolyte membrane layer. Specifically, electrons and protons are typically generated at the anode electro-catalyst. The electrons generated must find a path (e.g., the backing layer and a current collector) through which they can be transported to an external electric circuit. The protons generated at the anode electro-catalyst must be quickly transferred to the PEM layer through which they migrate to the cathode. Electro-catalyst sites are not productively utilized if the protons do not have a means for being quickly transported to the ion-conducting electrolyte. For this reason, coating the exterior surfaces of the electro-catalyst particles and/or electrode backing layer (carbon paper or fabric) with a thin layer of an ion-conductive ionomer has been used to increase the utilization of electro-catalyst exterior surface area and increase fuel cell performance by providing improved ion-conducting paths between the electro-catalyst surface sites and the PEM layer. Such an ion-conductive ionomer is typically the same material used as the PEM in the fuel cell. An ionomer is an ion-conducting polymer. For the case of a PEM fuel cell, the conducting ion is typically the proton and the ionomer is a proton-conducting polymer. The ionomer can be incorporated in the catalyst ink (precursor electro-catalyst composition) or can be applied on the catalyst-coated substrate afterwards. This approach has been followed by several groups of researchers, as summarized in the following patents [1-9]:
1) D. P. Wilkinson, et al., “Impregnation of micro-porous electro-catalyst particles for improving performance in an electrochemical fuel cell,” U.S. Pat. No. 6,074,773 (Jun. 13, 2000).
2) J. Zhang, et al., “Ionomer impregnation of electrode substrate for improved fuel cell performance,” U.S. Pat. No. 6,187,467 (Feb. 13, 2001).
3) I. D. Raistrick, “Electrode assembly for use in a solid polymer electrolyte fuel cell,” U.S. Pat. No. 4,876,115 (Oct. 24, 1989).
4) M. S. Wilson, “Membrane catalyst layer for fuel cells,” U.S. Pat. No. 5,211,984 (May 18, 1993).
5) J. M. Serpico, et al., “Gas diffusion electrode,” U.S. Pat. No. 5,677,074 (Oct. 14, 1997).
6) M. Watanabe, et al., “Gas diffusion electrode for electrochemical cell and process of preparing same,” U.S. Pat. No. 5,846,670 (Dec. 8, 1998).
7) T. Kawahara, “Electrode for fuel cell and method of manufacturing electrode for fuel cell,” U.S. Pat. No. 6,015,635 (Jan. 18, 2000).
8) S. Hitomi, “Solid polymer electrolyte-catalyst composite electrode, electrode for fuel cell, and process for producing these electrodes,” U.S. Pat. No. 6,344,291 (Feb. 5, 2002).
9) S. Hitomi, et al. “Composite catalyst for solid polymer electrolyte-type fuel cell and process for producing the same,” U.S. Pat. No. 6,492,295 (Dec. 10, 2002).
10) B. Srinivas and A. O. Dotson, “Proton Conductive Carbon Material for Fuel Cell,” US 2004/0109816 (Pub. Jun. 10, 2004).
11) B. Srinivas, “Sulfonated Carbonaceous Materials,” US 2004/0042955 (Pub. Mar. 4, 2004).
12) B. Srinivas, “Sulfonated Conducting Polymer-Grafted Carbon Material for Fuel Cell Applications,” US 2004/0110051 (Pub. Jun. 10, 2004).
13) B. Srinivas, “Conducting Polymer-Grafted Carbon Material for Fuel Cell Applications,” US 2004/0110052 (Pub. Jun. 10, 2004).
14) B. Srinivas, “Metallized Conducting Polymer-Grafted Carbon Material and Method for Making,” US 2004/0144961 (Pub. Jul. 29, 2004).
15) B. Srinivas, “Conducting Polymer-Grafted Carbon Material for Fuel Cell Applications,” US 2004/0166401 (Pub. Aug. 26, 2004).
16) B. Srinivas, “Sulfonated Conducting Polymer-Grafted Carbon Material for Fuel Cell Applications,” US 2004/0169165 (Pub. Sep. 2, 2004).

However, this prior-art approach [1-9] of ionomer impregnation into the electrode layer and/or onto electro-catalyst particle surfaces has a serious drawback in that the ionomer commonly used as the PEM material, although ion-conducting (proton-conducting), is not electronically conducting. This is due to the consideration that a proton-exchange membrane, when serving as the solid electrolyte layer, cannot be an electronic conductor; otherwise, there would be internal short-circuiting, resulting in fuel cell failure and possible fire hazard. Such an electronically non-conductive material, when coated onto the surface of a catalyst particle or carbon paper fiber, will render the catalyst particle or carbon fiber surface electronically non-conductive. This would prevent the electrons generated at the catalyst sites from being quickly collected by the anode electrode substrate layer and the current collector, thereby significantly increasing the Ohmic resistance and reducing the fuel cell performance. We recognized that this impregnation or coating material should not be the same ionomer used as the PEM material.

In our co-pending applications [(1) Bor Z. Jang, Aruna Zhamu, and Jiusheng Guo, “Process for Producing Fuel Cell Electrode, Catalyst-Coated Electrode, and Membrane-Electrode Assembly,” U.S. patent application Ser. No. 11/522,580 (Sep. 19, 2006); (2) “Electro-catalyst Composition, Fuel Cell Electrode, and Membrane-Electrode Assembly,” U.S. patent application Ser. No. 11/518,565 (Sep. 11, 2006); and (3) “Electro-catalyst Compositions for Fuel Cells,” U.S. patent application Ser. No. 11/582,912 (Oct. 19, 2006)], we disclosed a new class of electro-catalyst compositions and the processes for producing these compositions and their derived electrodes, catalyst-coated membranes (CCMs), and membrane electrode assemblies (MEAs) for PEM fuel cell applications. The electro-catalyst composition and a precursor electro-catalyst composition (e.g., ink or suspension), when used in the formation of a fuel cell catalytic electrode layer, results in a significantly improved power output. The precursor electro-catalyst composition, when deposited onto a substrate with the liquid removed, forms an electro-catalyst composition that essentially constitutes an electrode layer (a catalytic anode or cathode film). The substrate in this context can be a gas diffusion layer (carbon paper or cloth) or a PEM layer. Ultimately, the electro-catalyst is sandwiched between a gas diffusion layer and a PEM layer.

The electro-catalyst composition in the second co-pending application Ser. No. 11/518,565 (Sep. 11, 2006) comprises: (a) a catalyst un-supported or supported on an electronically conducting carrier (e.g., carbon black particles, CB); and (b) an ion-conducting and electron-conducting coating/impregnation material in physical contact with the catalyst (e.g., this impregnation material is coated on a surface of the carrier or the catalyst particles are embedded in this impregnation material), wherein the coating/impregnation material has an electronic conductivity no less than 110 S/cm (preferably no less than 10⁻² S/cm) and an ion conductivity no less than 10⁻⁵ S/cm (preferably no less than 10⁻³ S/cm). Typically, this coating/impregnation material is not chemically bonded to either the carbon black surface or the catalyst and this coating or impregnation material forms a contiguous matrix with the catalyst particles dispersed therein. This contiguous matrix, along with the conductive CB particles, forms bi-networks of charge transport paths (one for electrons and the other for protons) in a fuel cell electrode, leading to much improved fuel cell performance with much reduced resistive loss, higher catalyst utilization efficiency, and higher cell output voltage. The second co-pending application [No. 11/518,565 (Sep. 11, 2006)] also discloses a precursor composition (e.g., an ink) that leads to the formation of the desired electro-catalyst composition or catalytic electrode by simply removing the liquid ingredient from the ink (no chemical treatment required and no chemical bonding or reaction involved).

The third co-pending application [U.S. patent application Ser. No. 11/582,912 (Oct. 19, 2006)] discloses another class of precursor electro-catalyst compositions that lead to the desired electro-catalyst composition by removing the liquid medium from the composition and inducing a chemical conversion or reaction of other ingredient(s) in the precursor composition. This precursor electro-catalyst composition comprises a precursor molecular metal, which can be chemically converted to nano-scaled catalyst particles via heating or energy beam exposure (e.g., UV light, ion beam, Gamma radiation, or laser beam) during or after the precursor composition is deposited with its liquid ingredient being removed. The process for producing an electrode, its CCM and MEA from this precursor electro-catalyst composition is disclosed in the first co-pending application [U.S. Ser. No. 11/522,580 (Sep. 19, 2006)].

It may be noted that Srinivas [Ref. 10-16] prepared a group of sulfonated carbon black (CB) or conducting polymer-grafted CB particles for fuel cell applications. The sulfonated carbon material was typically obtained by reacting an anhydride with a sulfuric acid to first obtain an organic sulfate intermediate, which was then reacted with CB to impart SO₃H groups to the CB. Alternatively, a multiple-step diazoitization was used to impart Φ-SO₃H groups (Φ=a benzene ring). These groups were then coated with or bonded to a conducting polymer to improve the electronic conductivity of surface-treated CB particles. Further alternatively, a complex oxidative polymerization step was taken to graft a conducting polymer to CB surface, followed by sulfonation, or to obtain a grafted sulfonated conducting polymer from a sulfonated monomer [12-16]. The technology proposed by Srinivas is vastly different and patently distinct from our technology as represented by the present and the three co-pending applications in the following ways:

(1) Srinivas's compositions are basically carbon black (CB) particles with their surfaces chemically bonded with either SO₃H type functional groups or a mono-layer of conductive polymer chains. In essence, these are just surface-modified CB particles that contain a minute amount of surface functional groups and chains. In the resulting electrode, individual CB particles were being packed together but remaining as discrete particles (FIG. 1 of Ref. 12-14) in such a manner that the surface-bound chains were of insufficient amount to form a continuous matrix material of structural integrity. The requirement for these particles to strictly maintain a contiguous network is a major drawback of this prior art technology. First, it is not natural for discrete particles to form and maintain contiguity, unless the volume fraction of these particles is excessively high with respect to the surface-bound groups or chains. In such a high-loading situation (with only a small amount of surface bound groups or chains), the resulting cluster or aggregate structure is very weak in terms of mechanical strength and, hence, tends to form cracks and fail to perform its intended functions.

In contrast, the coating, impregnation or matrix material in our inventions is NOT chemically bonded to either the CB surface or the catalyst. More importantly, this coating, impregnation, or matrix material serves to form a contiguous matrix with the catalyst particles dispersed therein in such a fashion that the catalyst particles or their supporting CB particles do not have to form a contiguous structure in order to maintain two charge transport paths (one for electrons and the other for proton). This matrix material is both electron- and proton-conducting anyway. When the un-supported catalysts or supported catalysts, along with the matrix material, are cast into a thin electrode layer, the matrix material automatically provides the two charge transport networks (whether the catalyst particles or CB particles form a continuous network or not).

(2) Srinivas's compositions did not include those with un-supported catalyst particles. They have essentially worked on catalysts supported on surface-grafted or -bonded CB particles only.
(3) Srinivas's compositions involved complicated and time-consuming surface chemical bonding, grafting, and/or polymerization procedures. In contrast, our compositions involve physically dispersing catalysts or carbon-supported catalysts in a fluid (a benign solvent such as a mixture of water and isopropanol in which a proton- and electron-conducting polymer is dissolved). No chemical reaction is needed or involved.
(4) In the case of surface functionalization [10,11], an electronically non-conducting moiety is interposed between the CB and the conducting polymer, which could significantly reduce the local electron conductivity.
(5) It is known that only a small number of functional groups can be chemically bonded to a carbon surface and, hence, a very limited number of polymer chains are grafted to the surface. Such a surface-treated CB still has limited conductivity improvements. In fact, Srinivas could not even measure the electron and proton conductivity of these mono-layers of surface groups or grafted polymer chains. He had to mix the surface bonded CB particles with Nafion® prior to a conductivity measurement. The conductivity values obtained are not representative of the conductivities of surface-treated CB particles.
(6) Although Srinivas's CB particles might be individually proton- and electron-conductive on the surface, they must cluster together to form a contiguous structure to maintain an electron-conducting path and a proton-conducting path. This is not always possible when they are used to form an electrode bonded to a PEM surface or a carbon paper surface. Due to only an extremely thin layer of chemical groups or chains being bonded to an individual CB particle, the resulting electrode can be very fragile and interconnected pores (desirable for gas diffusion) tend to interrupt their contiguity. Operationally, it is very difficult to form an integral layer of catalytic electrode from these modified CB particles alone. These shortcomings are likely the reasons why the data provided by Srinivas showed very little improvement in performance of the fuel cell featuring these coated CB particles. For instance, FIG. 8 of Ref. 10 and FIG. 8 of Ref. 12 show that the best improvement achieved by surface-bonded CB particles was a voltage increase from 0.54 V to 0.59V at 700 mA/cm², less than 10% improvement. However, a decrease in voltage was observed at higher current densities. In contrast, our electro-catalyst compositions naturally form two charge transport paths, which are unlikely to be interrupted during the electrode formation process. We have consistently achieved outstanding fuel cell performance improvements (greater than 20% in many cases).

The instant invention differs from our three co-pending applications in several ways. One special feature of the instant invention is an electro-catalyst composite composition that comprises nano-scaled catalyst particles supported on highly electron-conducting nano-scaled carbon/graphite materials such as carbon nanotubes (CNTs), nanometer-thickness graphite platelets or nano-scaled graphene plates (NGPs), carbon nano-scrolls (CNS, formed by scrolling up NGPs), carbon nano-fibers (CNFs), and graphitic nano-fibers (GNFs, which are ultra-high temperature treated CNFs). These materials exhibit an electrical conductivity that is several orders of magnitude higher than that of carbon blacks (CB). Their electrical conductivity values are also typically much higher than those of the electron- and proton-conducting matrix polymers. These elongated particles (CNTs, NGPs, CNS, CNFs, and GNFs) have an ultra-high aspect ratio (largest dimension/smallest dimension) that enable the formation of a contiguous network of electron-conductive paths with a minimum amount of particles (i.e., a very low percolation threshold). Furthermore, these elongated particles are also of high strength and stiffness and, when dispersed in a polymer matrix, significantly reinforce the structural integrity of the matrix. This is essential to the durability of an electrode in a fuel cell that is subject to thermal and humidity cycling and mechanical impacts. This is another feature that prior art compositions (including Srinivas's) do not have.

A measure of the fuel cell performance is the voltage output from the cell for a given current density. Higher performance is associated with a higher voltage output for a given current density or higher current density for a given voltage output, resulting in a higher power output. More effective utilization of the electro-catalyst, particularly through optimization of the electron and ion transfer rates, enables the same amount of electro-catalyst to induce a higher rate of electrochemical conversion in a fuel cell resulting in improved performance. This was the main object of the present invention.

### SUMMARY OF THE INVENTION

The present invention provides an electro-catalyst composition for use in a fuel cell. In one preferred embodiment, the composition comprises (a) a catalyst supported on an electronically conducting, elongate-shape solid carrier particles selected from nanometer-thickness graphite platelets or NGPs, carbon nano-fibers (CNFs), graphitic nano-fibers (GNFs), carbon nanotubes (CNTs), carbon nano-scrolls (CNS), or a combination thereof; and (b) a proton-conductive and electron-conductive matrix material, wherein solid carrier particles are dispersed in the matrix material to form a composite and wherein the matrix material has an electronic conductivity no less than 10⁻⁴ S/cm and proton conductivity no less than 10⁻⁵ S/cm. Preferably, the electronic conductivity of the matrix is no less than 10⁻² S/cm and the proton conductivity of the matrix is no less than 10⁻³ S/cm. In one preferred embodiment, the carrier particles have an electronic conductivity no less than 100 S/cm and the resulting composite composition has an overall electronic conductivity no less than 10⁻¹ S/cm and proton conductivity no less than 10⁻⁴ S/cm.

The catalyst may be selected from transition metals, alloys, mixtures, and oxides that can be made into nano-scaled particles supported on the surface solid carrier particles. These carrier particles have at least two things in common: they are all highly electron-conducting (much more conducting than carbon black) and they are all elongate in shape with a high aspect ratio (largest dimension/smallest dimension at least greater than 10, preferably greater than 100). As a consequence, these elongated particles readily form a network of electron-conducting paths at a relatively low percolation threshold (as compared to spherical or other non-elongated particles such as carbon black). No chemical reaction or grafting occurs between the surface of these elongated, conductive particles and the matrix material.

Preferably, the matrix material comprises a polymer which is (a) a proton- and electron-conductive polymer, (b) a mixture of a proton-conducting polymer and an electron-conducting polymer, or (c) a mixture of a proton-conducting material (organic or inorganic) and an electron-conducting polymer.

The proton-conducting polymer may be selected from the group consisting of poly(perfluoro sulfonic acid), sulfonated polytetrafluoroethylene, sulfonated perfluoroalkoxy derivatives of polytetrafluoroethylene, sulfonated polysulfone, sulfonated poly(ether ketone), sulfonated poly (ether ether ketone), sulfonated polystyrene, sulfonated polyimide, sulfonated styrene-butadiene copolymers, sulfonated poly chloro-trifluoroethylene (PCTFE), sulfonated perfluoroethylene-propylene copolymer (FEP), sulfonated ethylene-chlorotrifluoroethylene copolymer (ECTFE), sulfonated polyvinylidenefluoride (PVDF), sulfonated copolymers of polyvinylidenefluoride with hexafluoropropene and tetrafluoroethylene, sulfonated copolymers of ethylene and tetrafluoroethylene (ETFE), polybenzimidazole (PBI), their chemical derivatives, copolymers, blends and combinations thereof.

The electron-conducting polymer may comprise a polymer selected from the group consisting of sulfonated polyaniline, sulfonated polypyrrole, sulfonated poly thiophene, sulfonated bi-cyclic polymers, their derivatives, and combinations thereof. These polymers are themselves also good proton-conductive materials. Un-sulfonated versions of these polymers are electron-conducting and can be mixed with a proton-conductive material to form a mixture, which can serves as a proton- and electron-conducting matrix material.

The present composite composition may be prepared from a precursor electro-catalyst composition comprising: (a) a catalyst dissolved or dispersed in a liquid; (b) a proton- and electron-conducting polymer dissolved or dispersed in this liquid; and (c) elongated conductive particles, wherein the electronic conductivity of the polymer, when measured in a solid state, is no less than 10⁻⁴ S/cm and the ion conductivity of the polymer, when measured in a solid state, is no less than 10⁻⁵ S/cm. The catalyst may be in the form of nanometer-scaled particles already deposited on the surface of elongated carrier particles prior to being dispersed in the liquid. This precursor composition may be a suspension as thin as an ink (inkjet printable or sprayable onto a carbon paper or PEM surface) or as thick as a paste (can be screen-printed or brushed onto a carbon paper or PEM surface to form an electrode). Upon printing, spraying, or brushing onto a substrate and removal (evaporation) of the liquid, the resulting catalytic electrode structure is typically a composite containing catalyst-supporting particles dispersed or embedded in the matrix material, which comprises a proton- and electron-conductive polymer.

The incorporation of such an ion- and proton-conducting polymer in an electro-catalyst composition makes a fuel cell electrode consisting of bi-networks of charge transport paths (one for electrons and the other for proton). Optionally, substantially interconnected pores may be formed in the electrode to help form a diffusion path for the fuel (e.g., hydrogen) or oxidant (e.g., oxygen). In this way, the whole electrode structure is basically an intertwine 3-D network of three paths for electrons, protons, and electro-chemical reactants, respectively. The incorporation of such an electro-catalyst composite composition in a fuel cell electrode, catalyst-coated membrane, or membrane electrode assembly leads to much improved fuel cell performance with much reduced Ohmic loss, higher catalyst utilization efficiency, and higher cell output voltage (given the same desired operating current density).

### BRIEF DESCRIPTION OF THE DRAWINGS

FIG. 1 (a) Schematic of a prior-art PEM fuel cell electrode structure; (b) Schematic of another prior-art PEM fuel cell electrode structure.

FIG. 2 Prior-art electro-catalyst composition composed of grafted carbon black particles packed to form a weak aggregate (e.g., FIG. 1(B) of B. Srinivas and A. O. Dotson, US 2004/0109816 (Pub. Jun. 10, 2004)).

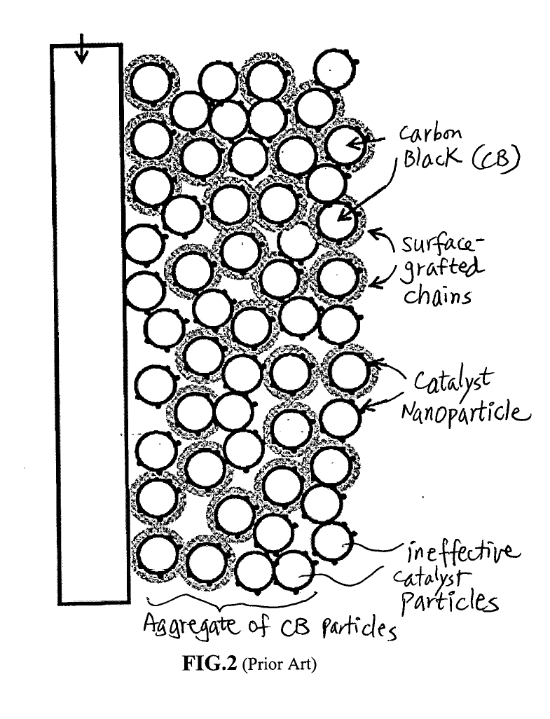

FIG. 3 A three-material model for a local catalyst-electrolyte-carbon fiber region in a prior-art fuel cell electrode.

FIG. 4 Schematic of an electrode structure according to a preferred embodiment of the present invention.

FIG. 5 The electron and proton conductivities of a proton- and electron-conductive polymer mixture.

FIG. 6 The polarization curves of two fuel cells, one containing electrode catalyst particles dispersed in a proton- and electron-conductive polymer blend matrix and the other containing electrode catalyst particles dispersed in a proton-conductive (but not electron-conductive) polymer, Nafion.

FIG. 7 The polarization curves of two fuel cells, one containing electrode catalyst particles dispersed in a proton- and electron-conductive polymer (sulfonated polyaniline) and the other containing electrode catalyst particles dispersed in a proton-conductive (but not electron-conductive) polymer, Nafion.

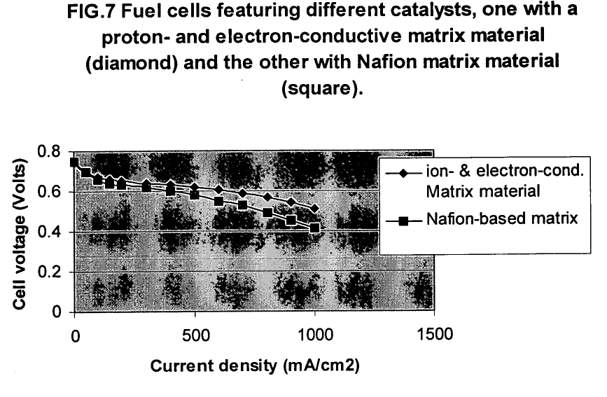

FIG. 8 The polarization curves of three fuel cells: first one containing carbon black-supported electrode catalyst particles dispersed in a proton- and electron-conductive polymer (sulfonated polyaniline); second one containing NGP-supported electrode catalyst particles dispersed in a proton- and electron-conductive polymer (sulfonated polyaniline); and the third one containing electrode catalyst particles dispersed in a proton-conductive (but not electron-conductive) polymer, Nafion.

### DETAILED DESCRIPTION OF THE PREFERRED EMBODIMENTS

A hydrogen-oxygen PEM-FC using hydrogen gas as the fuel and oxygen as the oxidant may be represented by the following electro-chemical reactions:

Anode: H₂→2H⁺+2e⁻ (Eq.(1))

Cathode: ½O₂+2H⁺+2e⁻→H₂O (Eq.(2))

Total reaction: H₂+½O₂→H₂O (Eq.(3))

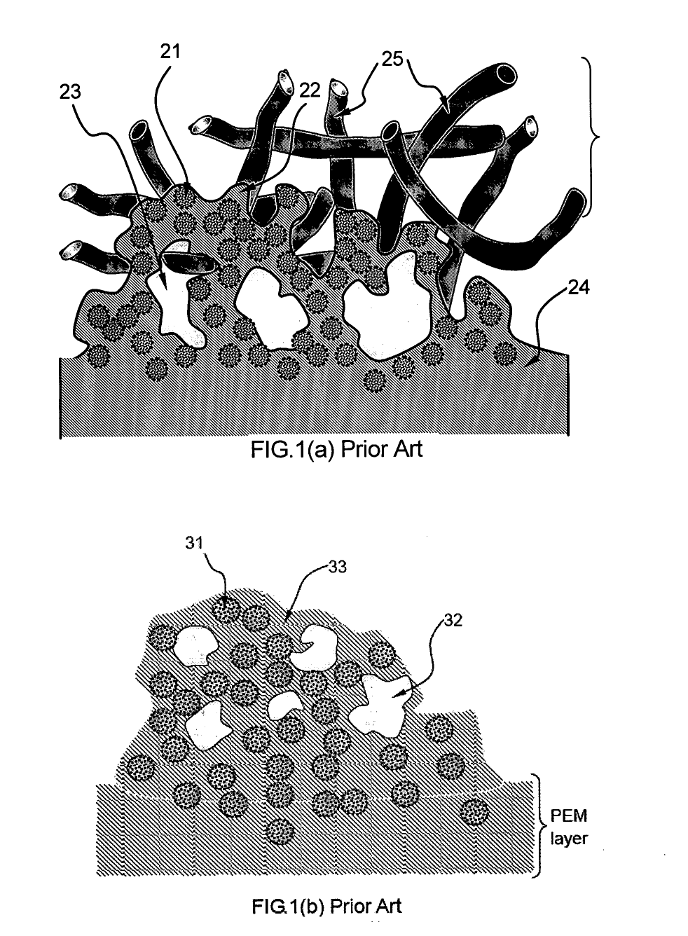

Both electrode reactions proceed only on a three-phase interface which allows the reception of gas (hydrogen or oxygen) and the delivery or reception of proton (H⁺) and electron (e⁻) at the same time. An example of the electrode having such a function is a solid polymer electrolyte-catalyst composite electrode comprising a solid polymer electrolyte and catalyst particles. FIG. 1(a) schematically shows the structure of such a prior art electrode. This electrode is a porous electrode comprising catalyst particles 21 and a solid polymer electrolyte 22 three-dimensionally distributed in admixture and having a plurality of pores 23 formed thereinside. The catalyst particles form an electron-conductive channel, the solid electrolyte forms a proton-conductive channel, and the pore forms a channel for the supply and discharge of oxygen, hydrogen or water as product. The three channels are three-dimensionally distributed and numerous three-phase interfaces which allow the reception or delivery of gas, proton (H⁺) and electron (e⁻) at the same time are formed in the electrode, providing sites for electrode reaction. In this diagram, reference numeral 24 represents an ion-exchange membrane (typically the same material as the solid polymer electrolyte 22 in all prior art electrode structures) while numeral 25 represents carbon or graphite fibers in a sheet of carbon paper as a catalyst backing layer.

The preparation of an electrode having such a structure has heretofore been accomplished typically by a process that comprises (a) preparing a paste of catalyst particles and, optionally, poly tetrafluoroethylene (PTFE) particles dispersed in a liquid, (b) applying (dispensing, depositing, spraying, or coating) the paste to a surface of a PEM or a porous carbon electrode substrate (carbon paper) of an electro-conductive porous material to make a catalyst film (normally having a layer thickness of from 3 to 30 μm), (c) heating and drying the film, and (d) applying a solid polymer electrolyte solution to the catalyst film so that the film is impregnated with the electrolyte. Alternatively, the process comprises applying a paste made of catalyst particles, PTFE particles, and a solid polymer electrolyte solution to a PEM or a porous carbon electrode substrate to make a catalyst film and then heating and drying the film. The solid polymer electrolyte solution may be obtained by dissolving the same composition as the aforementioned ion-exchange membrane (PEM) in an alcohol. PTFE particles are typically supplied with in a solution with the particles dispersed therein. PTFE particles typically have a particle diameter of approximately 0.2-0.3 μm. Catalyst particles are typically Pt or Pt/Ru nano particles supported on carbon black particles.

The aforementioned solid polymer electrolyte-catalyst composite electrode has the following drawbacks: The solid polymer electrolyte-catalyst composite electrode has a high electrical resistivity, which may be explained as follows. When catalyst particles are mixed with solid polymer electrolyte solution to prepare a paste, the catalyst particles are covered with solid polymer electrolyte film having extremely low electronic conductivity (10⁻¹⁶-10⁻¹³ S/cm). Upon completion of a film-making process to prepare an electrode, pores 32 and the non-conductive solid polymer electrolyte 33 tend to separate or isolate catalyst particles 33. The formation of a continuous catalyst particle passage (electron-conducting channel) is inhibited or interrupted, although a continuous solid electrolyte passage (proton-conducting channel) is maintained, as shown in the sectional view of electrode of FIG. 1(b).

Furthermore, by pressing the catalyst-electrolyte composite composition layer against the PEM layer to make a catalyst-coated membrane (CCM) and then a membrane electrode assembly (MEA), a significant amount of the carbon-supported catalyst particles tend to be embedded deep into the PEM layer (as illustrated by the bottom portion of FIG. 1(b)), making them inaccessible by electrons (if used as a cathode) or incapable of delivering electrons to the anode current collector (if used as an anode). As a result, the overall percent utilization of carbon-supported catalyst is significantly reduced.

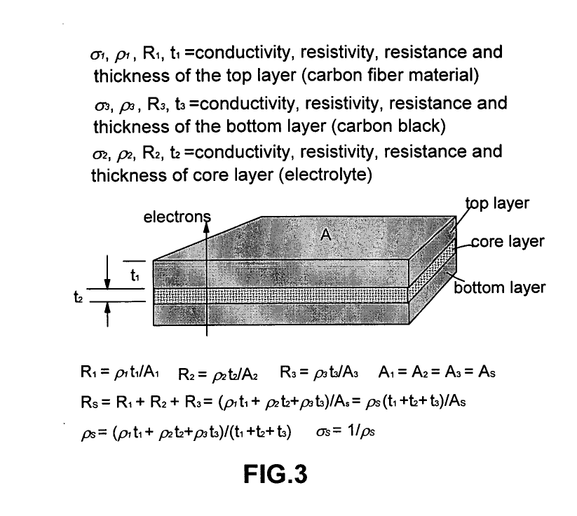

As shown in the upper portion of FIG. 1(a), the electronically non-conducting solid electrolyte 22 also severs the connection between the otherwise highly conductive catalyst-supporting carbon particles 21 and the carbon fibers 25 in the electrode-catalyst backing layer (carbon paper). This problem of solid electrolyte being interposed between a carbon particle and a carbon fiber is very significant and has been largely ignored by fuel cell researchers. The degree of severity of this problem is best illustrated by considering a three-layer model shown in FIG. 3. The model consists of top, core, and bottom layers that are electrically connected in series. The top layer represents a carbon fiber material, the bottom layer a carbon black particle material, and the core layer a solid electrolyte material. The total resistance (R_{S}), equivalent resistivity (ρₛ), and conductivity (σₛ) of the three-layer model can be easily estimated. For the top layer (carbon fiber), the properties or parameters are given as follows: conductivity (σ₁), resistivity (ρ₁), resistance (R₁), and thickness (t₁). Similar notations are given for the other two layers with subscript being “2” and “3”, respectively. FIG. 3 shows that the equivalent conductivity of the resulting three-layer model is σₛ=(t₁+t₂+t₃)/(ρ₁t₁+ρ₂t₂+ρ₃t₃). With t₁=10 μm, t₂=1 μm, and t₃=30 nm (0.03 μm), ρ₁=10⁻¹ Ωcm, ρ₂=10⁺¹⁴ Ωcm, and ρ₃=10⁺² Ωcm, we have σₛ≈10⁻¹³ S/cm. Assume that the electrolyte layer has a thickness as low as 1 nm (0.001 μm), the equivalent conductivity would be still as low as σₛ≈10⁻¹⁰ S/cm. It is clear that the equivalent conductivity of the local electrode environment (three-component model) is dictated by the low conductivity or high resistivity of the solid electrolyte (22 in FIG. 1(a) and 33 in FIG. 1(b)). These shockingly low conductivity values (10⁻¹³ to 10⁻¹⁰ S/cm) clearly have been overlooked by all of the fuel cell researchers. It could lead to significant power loss (Ohmic resistance) in a fuel cell.

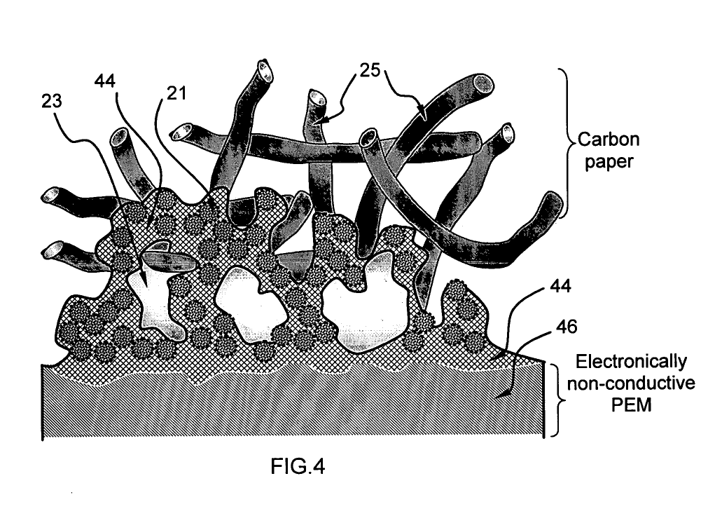

To effectively address the aforementioned issues associated with electro-catalysts in a fuel cell in general and a PEM-type fuel cell in particular, we decided to take a novel approach to the formulation of electro-catalysts. Rather than using the same solid electrolyte material as the PEM layer (which is ion-conductive but must be electronically non-conductive), we used a solid electrolyte material, which is both electron-conductive and ion-conductive, to serve as a matrix material to coat, impregnate, and/or embed catalyst particles, which are un-supported or supported on conductive particles like carbon black (e.g., FIG. 4). The solid electrolyte layer (e.g., PEM as indicated by numeral 24 in FIG. 1(a), or other organic or inorganic, ion-conductive solids,) interposed between the anode and the cathode remained to be proton-conductive, but not electron-conductive. This technology has been disclosed in three co-pending applications mentioned earlier. Instead of using carbon black or conventional graphite particles as the solid carrier, we have investigated the utilization of highly conducting, elongated-shape particles to support nano-scaled catalyst particles. Some surprising results that have good utility value have been observed, described as follows:

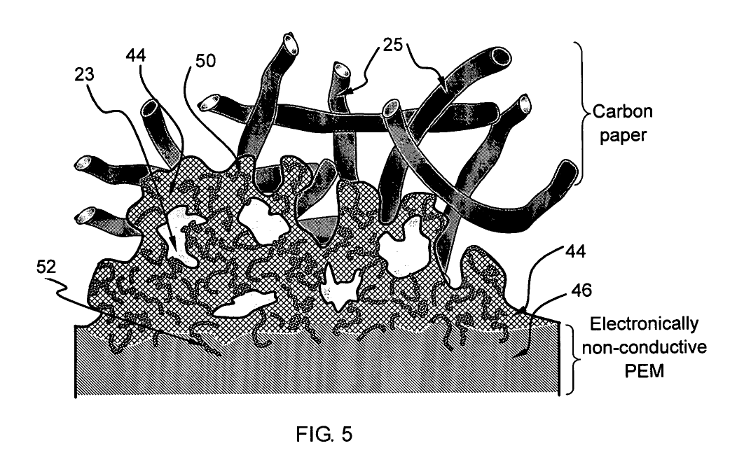

One of the preferred embodiments of the present invention is an electro-catalyst composite composition comprising: (a) a catalyst supported on an electronically conducting solid carrier in the form of elongate-shape solid particles and (b) a proton- and electron-conducting matrix material, wherein these elongate particles are dispersed in the matrix material to form a composite structure and the matrix material has an electronic conductivity no less than 10⁻⁴ S/cm (preferably no less than 10⁻² S/cm) and proton conductivity no less than 10⁻⁵ S/cm (preferably no less than 10⁻³ S/cm). The elongate carrier particles for supporting the catalyst are preferably selected from nanometer-thickness graphite platelets or NGPs, carbon nano-fibers (CNFs), graphitic nano-fibers (GNFs), carbon nanotubes (CNTs), carbon nano-scrolls (CNS), or a combination thereof. By contrast, described in one co-pending application (U.S. Ser. No. 11/518,565 (Sep. 11, 2006)) is an electro-catalyst composition that primarily makes use of carbon black particles as the catalyst-supporting carrier (schematically shown in FIG. 4). In the present application, the catalyst is preferably in the form of nanometer-scaled particles, typically smaller than 5 nm in diameter but preferably smaller than 2 nm. They may be selected from commonly used transition metal-based catalysts such as Pt, Pd, Ru, Mn, Co, Ni, Fe, Cr, and their alloys, mixtures, and oxides (these are given as examples and should not be construed as limiting the 6 scope of the present invention). Such a composite catalyst composition, comprising supported catalyst particles and the proton- and electron-conductive matrix material, can be attached to, coated on, or impregnated into a porous carbon paper on one side and attached to or coated on a PEM layer on another side (FIG. 5). This proton-conductive and electron-conductive matrix material preferably comprises a polymer, which can be a homo-polymer, co-polymer, polymer blend or mixture, a semi-interpenetrating network, or a polymer alloy. In this case, one polymer component can be proton-conductive and another one electron-conductive. It is also possible that a polymer itself is conductive to both electrons and protons. Examples will be given for these cases.

With this invented catalyst composite composition, the resulting electrode can be used as either an anode or a cathode. As shown in FIG. 5, when it is used in an anode, hydrogen gas or organic fuel can permeate to the electrode through the pores 23 or diffuse through the proton- and electron-conductive electrolyte material 44 (herein after also referred to as the matrix material), which is ultra-thin and can be readily migrated through via diffusion. Due to the high electronic 21 conductivity of both the matrix material 44 and the elongate carrier particles (e.g., 50,52 in FIG. 5), the electrons produced at the catalyst particles 21 can be quickly transported through the matrix material 44 and/or elongate carrier particles to carbon fibers 25 of a carbon paper and be collected with little resistance or resistive (Ohmic) loss. The produced protons are also capable of migrating through the invented proton- and electron-conductive matrix material 44 into the electronically non-conductive PEM layer 46, which is a conventional solid electrolyte layer interposed between an anode and a cathode.

If used as a cathode catalyst material, this solid electrolyte matrix material 44 allows the electrons that come from the external load to go to the catalyst particle sites where they meet with protons and oxygen gas to form water. The protons come from the anode side, through the PEM layer 46, and the matrix material 44 to reach the catalyst sites. Oxygen gas migrates through the pores 23 or the electrolyte matrix material 44 via diffusion. Again, the electrons are capable of being transported into the cathode without any significant Ohmic loss due to the high electronic conductivity of both the matrix material 44 and the highly conducting elongate particles (e.g., 50,52 in FIG. 5).

In one preferred embodiment, the proton-conductive and electron-conductive matrix material 44 comprises a polymer that is by itself both proton-conductive and electron-conductive. Examples of this type polymer are sulfonated polyaniline compositions, as described by Epstein, et al. (U.S. Pat. No. 5,137,991, Aug. 11, 1992):

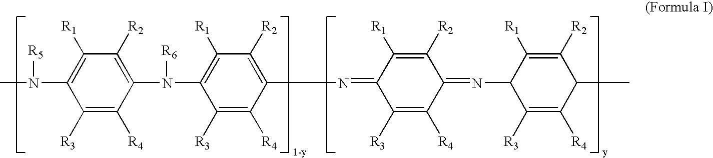

where 0≦y≦1, R₁, R₂, R₃, R₄, R₅, and R₆ are independently selected from the group consisting of H, So₃⁻, SO₃H, —R₇SO₃⁻, —R₇SO₃H, —OCH₃, —CH₃, —C₂H₅, —F, —Cl, —Br, —I, —OH, —O⁻, —SR₇, —OR₇, —COOH, —COOR₇, —COR₇, —CHO, and —CN, whereinR₇ is a C₁-C₈ alkyl, aryl, or aralkyl group, and wherein the fraction of rings containing at least one R₁, R₂, R₃, or R₄ group being an SO₃⁻, SO₃H, —R₇SO₃⁻, or —R₇SO₃H that varies from approximately 20% to 100%. It may be noted that this class of polymers was developed for applications that made use of their electronic properties. Due to their high electronic conductivity, these polymers cannot be used as a PEM interposed between an anode and a cathode in a fuel cell (PEM must be electronically non-conductive to avoid internal short-circuiting in a fuel cell). Hence, it is no surprise that the proton conductivity of these polymers has not been reported by Epstein, et al.

It is of interest at this juncture to re-visit the issue of ion and electron conductivities for this coating material. The proton conductivity of a conventional PEM material is typically in the range of 10⁻³ S/cm to 10⁻¹ S/cm (resistivity p of 10¹ Ω-cm to 10³ Ω-cm). The thickness (t) of a PEM layer is typically in the vicinity of 100 μm and the active area is assumed to be A=100 cm². Then, the resistance to proton flow through this layer will be R=ρ(t/A)=10⁻³Ω to 10⁻¹Ω. Further assume that the resistance of the matrix material (the proton- and electron-conductive material) will not add more than 10% additional resistance, then the maximum resistance of the matrix material will be 10⁻⁴Ω to 10⁻²Ω. With a matrix layer thickness of 1 μm, the resistivity to proton flow cannot exceed 10² Ω-cm to 10⁴ Ω-cm (proton conductivity no less than 10⁻⁴ S/cm to 10⁻² S/cm). With an intended matrix layer thickness of 0.1 μm (100 nm), the proton conductivity should be no less than 10⁻⁵ S/cm to 10⁻³ S/cm.

Similar arguments may be used to estimate the required electronic conductivity of the matrix material. Consider that the electrons produced at the catalyst surface have to pass through an electrolyte matrix layer (0.1 μm or 100 nm thick) and a carbon paper layer (100 μm in thickness with average transverse conductivity of 10⁻¹ S/cm to 10⁺¹ S/cm). A reasonable requirement is for the matrix layer to produce a resistance to electron flow that is comparable to 10% of the carbon paper resistance. This implies that the electronic conductivity of the matrix material should be in the range of 10⁻³ S/cm to 10⁻¹ S/cm. These values can be increased or decreased if the matrix layer thickness is increased or decreased. It may be further noted that conventional PEM materials have an electronic conductivity in the range of 10⁻¹⁶-10⁻¹³ S/cm, which could produce an enormous power loss.

We therefore decided to investigate the feasibility of using sulfonated polyaniline (S-PANi) materials as a component of an electro-catalyst material. After an extensive study, we have found that the most desirable compositions for use in practicing the present invention are for R₁, R₂, R₃, and R₄ group in Formula I being H, SO₃⁻ or SO₃H with the latter two varied between 30% and 75% (degree of sulfonation between 30% and 75%). The proton conductivity of these SO₃⁻ or SO₃H-based S-PANi compositions increases from 3×10³ S/cm to 4×10⁻² S/cm and their electron conductivity decreases from 0.5 S/cm to 0.1 S/cm when the degree of sulfonation is increased from approximately 30% to 75% (with y being approximately 0.4-0.6). These ranges of electron and proton conductivities are reasonable, particularly when one realizes that only a very thin film of S-PANi is used (typically much thinner than 1 μm and can be as thin as nanometers). A polymer of this nature can be used alone as a proton- and electron-conductive material. We have further found that these polymers are soluble in a wide range of solvents and are chemically compatible (miscible and mixable) with the commonly used proton-conductive polymers such as those represented by Formula IV-VII, to be described later. Hence, these S-PANi polymers also can be used in combination with a proton-conducting polymer to embed the dispersed electro-catalyst particles.

The aforementioned class of S-PANi was prepared by sulfonating selected polyaniline compositions after polymer synthesis. A similar class of soluble aniline polymer could be prepared by polymerizing sulfonic acid-substituted aniline monomers. The synthesis procedures are similar to those suggested by Shimizu, et al. (U.S. Pat. No. 5,589,108, Dec. 31, 1996). The electronic conductivity of this class of material was found by Shimizu, et al. to be between 0.05 S/cm and 0.2 S/cm, depending on the chemical composition. However, proton conductivity was not measured or reported by Shimizu, et al. We have found that the proton conductivity of this class of polymers typically ranges from 4×10⁻³ S/cm to 5×10⁻² S/cm, depending on the degree of sulfonation. It appears that both proton and electron conductivities of these polymers are well within acceptable ranges to serve as a proton- and electron-conductive polymer for use in the presently invented fuel cell catalyst compositions. Again, these polymers are soluble in a wide range of solvents and are chemically compatible (miscible and mixable) with commonly used proton-conductive polymers such as those represented by Formula IV-VII, to be described later. Hence, these polymers not only can be used alone as a proton- and electron-conductive polymer, but also can be used an electron-conductive polymer component that forms a mixture with a proton-conductive polymer.

The needed proton- and electron-conducting matrix polymer can be a mixture or blend of an electrically conductive polymer and a proton-conductive polymer with their ratio preferably between 20/80 to 80/20. The electron-conductive polymer component can be selected from any of the π electron conjugate chain polymers, doped or un-doped, such as derivatives of polyaniline, polypyrrole, polythiophene, polyacetylen, and polyphenylene provided they are melt- or solution-processable. A class of soluble, electron-conductive polymers that can be used in the present invention has a bi-cyclic chemical structure represented by Formula II:

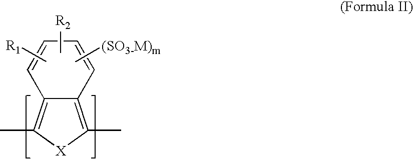

wherein R₁ and R₂ independently represent a hydrogen atom, a linear or branched alkyl or alkoxy group having 1 to 20 carbon atoms, a primary, secondary or tertiary amino group, a trihalomethyl group, a phenyl group or a substituted phenyl group, X represents S, O, Se, Te or NR₃, R₃ represents a hydrogen atom, a linear or branched alkyl group having 1 to 6 carbon atoms or a substituted or unsubstituted aryl group, providing that the chain in the alkyl group of R₁, R₂, or R₃, or in the alkoxy group of R₁ or R₂ optionally contains a carbonyl, ether or amide bond, M represents H⁺, an alkali metal ion such as Na⁺, Li⁺, or K⁺ or a cation such as a quaternary ammonium ion, and m represents a numerical value in the range between 0.2 and 2. This class of polymers was developed for the purpose of improving solubility and processability of electron-conductive polymers (Saida, et al., U.S. Pat. No. 5,648,453, Jul. 15, 1997). These polymers are also soluble in a wide range of solvents (including water) and are chemically compatible (miscible and mixable) with the proton-conductive polymers represented by Formula IV-VII, to be described later. These polymers exhibit higher electronic conductivity when both R₁ and R₂ are H, typically in the range of 5×10⁻² S/cm to 1.4 S/cm. These polymers are also proton-conductive (proton conductivity of 5×10⁻⁴ S/cm to 1.5×10⁻² S/cm) and hence can be used in the presently invented catalyst composition, alone or in combination with another ion-conductive or electron-conductive polymer.

Polymers which are soluble in water and are electronically conductive may be prepared from a monomer that has, as a repeat unit, a thiophene or pyrrole molecule having an alkyl group substituted for the hydrogen atom located in the beta position of the thiophene or pyrrole ring and having a surfactant molecule at the end of the alkyl chain (Aldissi, et al., U.S. Pat. No. 4,880,508, Nov. 14, 1989):

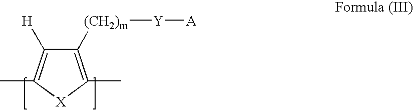

In these polymers, the monomer-to-monomer bonds are located between the carbon atoms which are adjacent to X, the sulfur or nitrogen atoms. The number (m) of carbon atoms in the alkyl group may vary from 1 to 20 carbon atoms. The surfactant molecule consists of a sulfonate group (Y═SO₃), or a sulfate group (Y═SO₄), or a carboxylate group (Y═CO₂), and hydrogen (A=H) or an alkali metal (A=Li, Na, K, etc.). Synthesis of these polymers may be accomplished using the halogenated heterocyclic ring compounds 3-halothiophene or 3-halopyrrole as starting points; these are available from chemical supply houses or may be prepared by method known to those skilled in the art. The electronic conductivity of these polymers is typically in the range of 10⁻³ S/cm to 50 S/cm.

The ion- or proton-conductive polymer can be any polymer commonly used as a solid polymer electrolyte in a PEM-type fuel cell. These PEM materials are well-known in the art. One particularly useful class of ion-conductive polymers is the ion exchange membrane material having sulfonic acid groups. These materials are hydrated when impregnated with water, with hydrogen ion H⁺ detached from sulfonic ion, SO₃⁻. The general structure of the sulfonic acid membranes that have received extensive attention for use in fuel cells and are sold under the trade name Nafion® by E.I. du Pont Company is as follows:

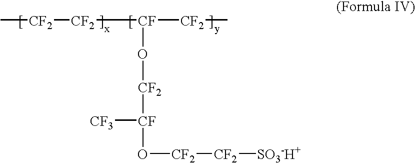

where x and y are integers selected from 1 to 100,000, preferably from 1 to 20,000, most preferably from 100 to 10,000. A similar polymer that is also suitable for use as a PEM is given as:

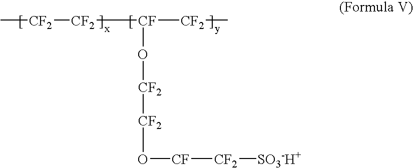

Sulfonic acid polymers having a shorter chain between the pendant functional group (side group) and the main polymer backbone absorb less water at a given concentration of functional group in the polymer than do polymers having the general structure as shown by Formula IV and V. The concentration of functional group in the dry polymer is expressed as an equivalent weight. Equivalent weight is defined, and conveniently determined by standard acid-base titration, as the formula weight of the polymer having the functional group in the acid form required to neutralize one equivalent of base. In a more general form, this group of proton-conducting polymers may be represented by the formula:

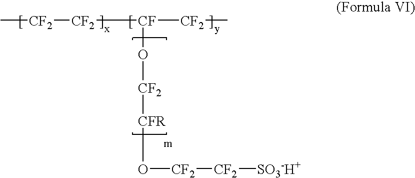

where x and y are integers selected from 1 to 100,000, m is an integer selected from 0 to 10 and R is a functional group selected from the group consisting of H, F, Cl, Br, I, and CH₃.

Another class of PEM polymer suitable for use as an ion-conductive polymer in the present invention is characterized by a structure having a substantially fluorinated backbone which has recurring pendant groups attached thereto and represented by the general formula:

—O(CFR_{f}′)_{b}− (CFR_{f})ₐ—SO₃H (Formula VII)

where a=0−3, b=0−3, a+b=at least 1, R_{f} and R_{f}′ are independently selected from the group consisting of a halogen and a substantially fluorinated alkyl group having one or more carbon atoms.

The above polymers have a detachable hydrogen ion (proton) that is weakly attached to a counter-ion (e.g., SO₃⁻), which is covalently bonded to a pendant group of the polymer. While the general structures shown above are representative of several groups of polymers of the present invention, they are not intended to limit the scope of the present invention. It would become obvious to those skilled in the art, from the relationships presented herein that other sulfonic acid functional polymers having pendant chains, sterically hindered sulfonate groups or the like would absorb some water and conduct protons. For instance, the derivatives and copolymers of the aforementioned sulfonic acid polymers, alone or in combination with other polymers to form polymer blends, may also be used as an ion-conductive material in the invented fuel cell catalyst composition. The aforementioned polymers were cited as examples to illustrate the preferred mode of practicing the present invention. They should not be construed as limiting the scope of the present invention.

In summary, the proton-conducting polymer component of the desired mixture may be selected from the group consisting of poly(perfluoro sulfonic acid), sulfonated poly (tetrafluoroethylene), sulfonated perfluoroalkoxy derivatives of polytetrafluoroethylene, sulfonated polysulfone, sulfonated poly(ether ketone), sulfonated poly (ether ether ketone), sulfonated polyimide, sulfonated styrene-butadiene copolymers, sulfonated polystyrene, sulfonated poly chloro-trifluoroethylene (PCTFE), sulfonated perfluoroethylene-propylene copolymer (FEP), sulfonated ethylene-chlorotrifluoroethylene copolymer (ECTFE), sulfonated poly vinylidenefluoride (PVDF), sulfonated copolymers of polyvinylidenefluoride with hexafluoropropene and tetrafluoroethylene, sulfonated copolymers of ethylene and tetrafluoroethylene (ETFE), polybenzimidazole (PBI), their chemical derivatives, copolymers, blends and combinations thereof. These materials have been used as solid electrolyte materials for various PEM-based fuel cells due to their relatively good proton conductivity (typically between 0.1 S/cm and 0.001 S/cm).

Any of these proton-conductive materials can be mixed with an electron-conductive polymer to make a polymer blend or mixture that will be conductive both electronically and ionically. Such a mixture is prepared preferably by dissolving both the proton-conductive polymer and the electron-conductive polymer in a common solvent to form a polymer solution. Catalyst particles (e.g., nano-scaled Pt particles already supported on the surface of NGP particles, or Pt particles and NGP particles separately) are then added to this polymer solution to form a suspension. Alternatively, catalyst particles may be dispersed in a liquid to obtain a suspension, which is then poured into the polymer solution to form a precursor composite catalyst composition. Nano-scaled catalyst particles may be selected from commonly used transition metal-based catalysts such as Pt, Pd, Ru, Mn, Co, Ni, Fe, Cr, and their alloys or mixtures. They are commercially available in a fine powder form or in a liquid with these nano-scaled particles dispersed therein. Other types of catalyst, including oxides of transition metals and organo-metallic compound, may be used as a component in the presently invented precursor composite electro-catalyst composition provided that they or their precursors can be dissolved or dispersed in a liquid. Mixing between a proton-conductive polymer and an electron-conductive polymer may also be accomplished by melt mixing or melt extrusion.

A suspension can be prepared in this manner to contain only an electron-conductive and proton-conductive polymer (or a mixture of two or three polymers) dissolved or dispersed in a solvent. Such a catalyst-free suspension is also a useful material that can be coated to a primary surface of a carbon paper or a primary surface of a solid PEM layer. This is followed by depositing a thin film of the presently invented composite electro-catalyst composition from a precursor suspension onto either the carbon paper or the PEM layer. Such a catalyst-free coating serves to ensure that the coated catalysts will have a complete electronic connection with the carbon paper and complete ionic connection with the PEM layer. The resulting electrode is characterized in that the elongated carrier particles along with the supported Pt nano-particles are not surrounded by the electronically non-conductive PEM polymer after lamination to form a membrane-electrode assembly.

### EXAMPLE 1

### Preparation of poly (alkyl thiophene) as an Electron-Conductive Component

Water-soluble conductive polymers having a thiophene ring (X=sulfur) and alkyl groups containing 4, 6, 8, and 10 carbon atoms (m=4, 6, 8, or 10) in Formula III were prepared, according to a method adapted from Aldissi, et al. (U.S. Pat. No. 4,880,508, Nov. 14, 1989). The surfactant molecules of these polymers were sulfonate groups with sodium, hydrogen, or potassium. Conductivity of polymers of this invention in a self-doped state were from about 10⁻³ to about 10⁻² S/cm. When negative ions from a supporting electrolyte used during synthesis were allowed to remain in the polymer, conductivities up to about 50 S/cm were observed. Conductivities of polymers without negative ions from a supporting electrolyte which were doped with vaporous sulfuric acid were about 10² S/cm.

A doped poly (alkyl thiophene) (PAT) with Y═SO₃H and A=H in Formula III that exhibited an electron conductivity of 12.5 S/cm was dissolved in water. A sulfonated poly(ether ether ketone)(PEEK)-based material called poly (phthalazinon ether sulfone ketone) (PPESK) was purchased from Polymer New Material Co., Ltd., Dalian, China. With a degree of sulfonation of approximately 93%, this polymer was soluble in an aqueous hydrogen peroxide (H₂O₂) solution. A water solution of 3 wt. % poly (alkyl thiophene) and an aqueous H₂O₂ solution of 3 wt. % sulfonated PPESK was mixed at several PPESK-to-PAK ratios and stirred at 70° C. to obtain several polymer blend solution samples.

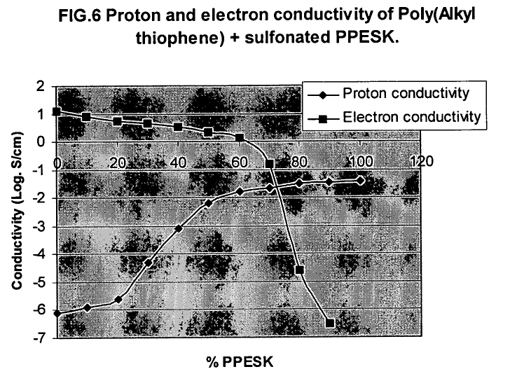

Samples of poly (alkyl thiophene)-PPESK mixtures in a thin film form were obtained by casting the aforementioned solutions onto a glass plate, allowing water to evaporate. The proton and electron conductivity values of the resulting solid samples were then measured at room temperature. The results were shown in FIG. 6, which indicates that good electron and proton conductivities can be obtained within the range of 30-75% PPESK.

### EXAMPLE 2

### Inks (Suspensions) Containing poly (alkyl thiophene), PPESK, Carbon Black-Supported Pt or Pt/Ru

Carbon black-supported Pt and Pt/Ru catalyst particles were separately added and dispersed in two aqueous polymer blend solutions prepared in Example 1. The PPESK-to-PAK ratio selected in both solutions was 1:1. The viscosity of the resulting solutions (more properly referred to as suspensions or dispersions) was adjusted to vary between a tooth paste-like thick fluid and a highly dilute “ink”, depending upon the amount of water used. These suspensions can be applied to a primary surface of a carbon paper or that of a PEM layer (e.g. Nafion or sulfonated PEEK sheet) via spraying, printing (inkjet printing or screen printing), brushing, or any other coating means.

A suspension comprising carbon black-supported Pt particles dispersed in an aqueous solution of PPESK and PAK was brushed onto the two primary surfaces of a Nafion sheet with the resulting catalyst-coated membrane (CCM) being laminated between two carbon paper sheets to form a membrane electrode assembly (MEA). In this case, the electrode was characterized in that the carbon black along with the supported Pt nano-particles were coated by or embedded in an ion- and electron-conductive polymer blend. A similar MEA was made that contained conventional Nafion-coated catalyst particles, wherein Nafion is only ion-conductive, but not electron-conductive. The two MEAs were subjected to single-cell polarization testing with the voltage-current density curves shown in FIG. 6. It is clear that coating the catalyst particles with an electron- and ion-conductive polymer mixture significantly increases the voltage output of a fuel cell compared with that of a conventional fuel cell with Nafion-coated catalysts. This implies a more catalyst utilization efficiency and less power loss (lesser amount of heat generated).

### EXAMPLE 3

### Sulfonated polyaniline (S-PANi)

The chemical synthesis of the S-PANi polymers was accomplished by reacting polyaniline with concentrated sulfuric acid. The procedure was similar to that used by Epstein, et al. (JS Patent No. 5,109,070, Apr. 28, 1992). The resulting S-PANi can be represented by Formula I with R₁, R₂, R₃, and R₄ group being H, SO₃⁻ or SO₃H with the latter two being varied between 30% and 75% (degree of sulfonation between 30% and 75%). The proton conductivity of these So₃⁻ or SO₃H-based S-PANI) compositions was in the range of 3×10⁻³ S/cm to 4×10⁻² S/cm and their electron conductivity of 0.1 S/cm to 0.5 S/cm when the degree of sulfonation was from approximately 30% to 75% (with y being approximately 0.4-0.6).

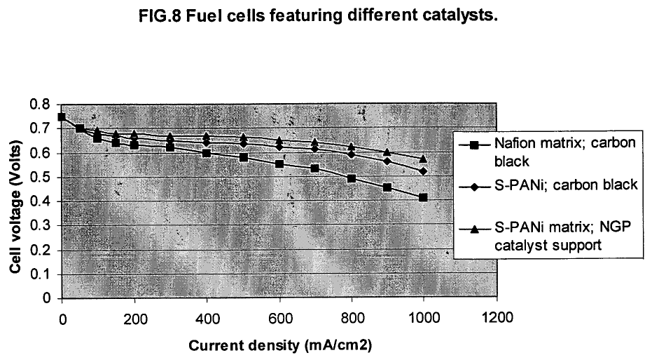

A sample with the degree of sulfonation of about 65% was dissolved in 0.1 M NH₄OH up to approximately 20 mg/ml. A small amount of NGP-supported Pt was added to the S-PANi solution to obtain a suspension that contained approximately 5% by volume of solid particles. The suspension was sprayed onto the two primary surfaces of a Nafion-based PEM sheet with the resulting catalyst-coated membrane (CCM) being laminated between two carbon paper sheets to form a membrane electrode assembly (MEA). Prior to this lamination step, one surface of the carbon paper, the one facing the catalyst, was pre-impregnated with a thin layer of S-PANi via spraying of the S-PANi solution onto the paper surface and allowing the solvent to evaporate under a chemical fume hood. The resulting electrode was characterized in that the NGP particles along with the supported Pt nano-particles were embedded in an ion- and electron-conductive matrix polymer. The electrode was also porous, providing channels for fuel or oxidant transport. A second MEA was produced with NGP replaced by conventional carbon black particles serving as a catalyst carrier. The matrix material remains to be S-PANi). A third similar MEA was made that contained conventional Nafion-based matrix material (with carbon black serving as a catalyst carrier), wherein Nafion is only ion-conductive, but not electron-conductive. The three MEAs were subjected to single-cell polarization testing with the voltage-current density curves shown in FIG. 8. These results demonstrate that embedding the catalyst particles in an electron- and ion-conductive polymer matrix to form a catalytic composite composition significantly increases the voltage output of a fuel cell compared with that of a conventional fuel cell with the Nafion-based composite. Furthermore, NGP-based carrier particles in a proton- and electron-conducting matrix material exhibit a consistently better performance compared to carbon black-based carrier particles, quite likely due to the much higher conductivity of NGP particles.

### EXAMPLE 4

### Bi-cyclic Conducting Polymers

The preparation of conductive polymers represented by Formula II having H for both R₁ and R₂, S for X, and H⁺ for M was accomplished by following a procedure suggested by Saida, et al. (U.S. Pat. No. 5,648,453, Jul. 15, 1997). These polymers exhibit electronic conductivity in the range of 5×10⁻² S/cm to 1.4 S/cm and proton conductivity of 5×10⁻⁴ S/cm 1.5×10⁻² S/cm.

Six polymer blends were prepared from such a bi-cyclic polymer (electron conductivity σₑ=1.1 S/cm and proton conductivity σₚ=3×10⁻³ S/cm) and approximately 50% by wt. of the following proton-conductive polymers: poly (perfluoro sulfonic acid) (PPSA), sulfonated PEEK (S-PEEK), sulfonated polystyrene (S-PS), sulfonated PPESK, sulfonated polyimide (S-PI), and sulfonated polyaniline (S-PANi). The conductivities of the resulting polymer blends are σₑ=0.22 S/cm and σₚ=2×10⁻² S/cm for (bi-cyclic+PPSA), σₑ=0.2 S/cm and σₚ=7×10⁻³ S/cm for (bi-cyclic+S-PEEK), σₑ=0.23 S/cm and σₚ=5.5×10⁻³ S/cm for (bi-cyclic+S-PS), σₑ=0.19 S/cm and σₚ=6×10⁻³ S/cm for (bi-cyclic+S-PPESK), σₑ=0.21 S/cm and σₚ=7.5×10⁻³ S/cm for (bi-cyclic+S-PI), and σₑ=0.75 S/cm and σₚ=3×10⁻³ S/cm for (bi-cyclic+S-PANi), These conductivity values are all within the acceptable ranges for these polymer blends to be a good matrix material for embedding the catalyst particles in a fuel cell electrode.

What is claimed:

1. An electro-catalyst composite composition for use in a fuel cell, said composite composition comprising:
(a) a catalyst supported on electronically conducting, elongate-shape solid carrier particles with an aspect ratio greater than 10; and
(b) a proton-conductive and electron-conductive matrix material;
wherein said solid carrier particles are dispersed in said matrix material to form a composite structure and said matrix material has an electronic conductivity no less than 10⁻⁴ S/cm and a proton conductivity no less than 10⁻⁵ S/cm.

2. The electro-catalyst composite composition as defined in claim 1, wherein said carrier particles comprise species selected from nanometer-thickness graphite platelets, carbon nano-fibers, graphitic nano-fibers, carbon nanotubes, carbon nano-scrolls, or a combination thereof.

3. The electro-catalyst composite composition as defined in claim 1, wherein no chemical reaction, grafting, or covalent bonding occurs between said solid carrier particles and said matrix material.

4. The electro-catalyst composite composition as defined in claim 1, wherein said elongate-shape solid carrier particles have an aspect ratio greater than 100.

5. The electro-catalyst composite composition as defined in claim 1, further comprising pores that are interconnected.

6. The electro-catalyst composite composition as defined in claim 1, wherein said matrix electronic conductivity is no less than 10⁻² S/cm, said matrix proton conductivity is no less than 10⁻³ S/cm, and said carrier particles have an electronic conductivity no less than 100 S/cm.

7. The electro-catalyst composite composition as defined in claim 1, wherein said matrix material comprises a proton-conducting polymer selected from the group consisting of poly(perfluoro sulfonic acid), sulfonated polytetrafluoroethylene, sulfonated perfluoroalkoxy derivatives of polytetra-fluoroethylene, sulfonated polysulfone, sulfonated poly(ether ketone), sulfonated poly (ether ether ketone), sulfonated polystyrene, sulfonated polyimide, sulfonated styrene-butadiene copolymers, sulfonated poly chloro-trifluoroethylene, sulfonated perfluoroethylene-propylene copolymer, sulfonated ethylene-chlorotrifluoroethylene copolymer, sulfonated polyvinylidenefluoride, sulfonated copolymers of polyvinylidenefluoride with hexafluoropropene and tetrafluoroethylene, sulfonated copolymers of ethylene and tetrafluoroethylene, polybenzimidazole, and chemical derivatives, copolymers, and blends thereof.

8. The electro-catalyst composite composition as defined in claim 1, wherein said matrix material comprises an electron-conducting polymer or a proton-conducting polymer.

9. The electro-catalyst composite composition as defined in claim 1, wherein said matrix material comprises an electrically conducting polymer selected from the group consisting of sulfonated polyaniline, sulfonated polypyrrole, sulfonated poly thiophene, sulfonated bi-cyclic polymers, derivatives thereof, and combinations thereof.

10. The electro-catalyst composite composition as defined in claim 1, wherein said matrix material comprises a mixture of an ion-conducting polymer and an electron-conducting polymer.

11. The electro-catalyst composite composition as defined in claim 1, wherein said matrix material comprises a proton-conducting polymer which is also electronically conducting.

12. The electro-catalyst composite composition as defined in claim 7, further comprising an electronically conducting polymer which forms a polymer blend with said proton-conducting polymer.

13. The electro-catalyst composite composition as defined in claim 1, wherein said matrix material comprises a proton-conducting or an electron-conducting polymer and said composite composition further comprises unsupported discrete catalyst particles dispersed in said polymer.

14. The electro-catalyst composite composition as defined in claim 1, wherein said catalyst comprises a transition metal element.

15. The electro-catalyst composite composition as defined in claim 1, wherein said solid carrier particles further comprise non-elongated graphite particles and/or carbon black particles.

16. The electro-catalyst composite composition as defined in claim 1, wherein said carrier particles are further grafted with a proton- and/or electron-conducting polymer and said grafted particles are dispersed in said matrix material.

17. A fuel cell electrode comprising an electro-catalyst composite composition defined in claim 1.

18. A fuel cell membrane-electrode assembly comprising an electro-catalyst composition defined in claim 1.

19. A coated proton-exchange membrane (PEM) comprising an electro-catalyst composite composition defined in claim 1, wherein said composite composition is coated on a surface or two opposing surfaces of said membrane.

20. A fuel cell gas diffusion layer comprising an electro-catalyst composite composition defined in claim 1, wherein said gas diffusion layer is coated with or impregnated with said composite composition.

21. The fuel cell membrane electrode assembly as defined in claim 18, further comprising a porous catalyst-backing layer with a primary surface coated with an ion-conductive and electron-conductive material which is in electronic contact with said electro-catalyst composite composition.

22. The fuel cell membrane electrode assembly as defined in claim 21 wherein said porous catalyst backing layer comprises a carbon paper or carbon cloth.

23. A fuel cell comprising therein an electro-catalyst composite composition as defined in claim 1.

24. An electro-catalyst composite composition for use in a fuel cell, said composite composition comprising:
(a) nanometer-scaled catalyst particles supported on electronically conducting, elongate-shape solid carrier particles; and
(b) a proton-conductive and electron-conductive matrix material;
wherein said solid carrier particles are dispersed in said matrix material to form a composite structure that has an electronic conductivity no less than 10⁻³ S/cm and a proton conductivity no less than 10⁻⁴ S/cm.
